(19) United States
(12) Patent Application Publication
(10) Pub. No.: US 2018/0210545 A1
(43) Pub. Date: Jul. 26, 2018

(54) Method Of Navigating Viewable Content Within A Virtual Environment Generated By A Virtual Reality System

(71) Applicant: Avantis Systems Ltd, Quedgeley (GB)

(72) Inventors: Nik Tuson, Quedgeley (GB); Rupert Rawnsley, Quedgeley (GB)

(21) Appl. No.: 15/880,473

(22) Filed: Jan. 25, 2018

(30) Foreign Application Priority Data
Jan. 25, 2017 (GB) 1701265.9

(51) Int. Cl. G06F 3/01; G06T 19/00; G06F 3/0346

(52) U.S. Cl. CPC G06F 3/012; G06T 19/003; G02B 27/017; G06F 3/0346; G06F 3/017

(57) ABSTRACT

A method of navigating viewable content within a virtual environment generated by a virtual reality system is disclosed. The virtual reality system comprises a display for displaying the virtual environment comprising viewable content in a virtual reference frame to a user, and at least one head mountable sensor for sensing a tilt of the user's head in a real reference frame. The method comprises the steps of moving the virtual reference frame relative to the real reference frame in response to the tilt of the user's head to present the viewable content to the viewer.

The present invention relates to a method of navigating viewable content in a virtual environment generated by a virtual reality system.

Virtual reality systems typically comprise a headset which is worn by a user to present a 3-dimensional view of a virtual environment. The view experienced by the user depends on the direction the user is facing within the environment to create the impression that the user is completely immersed within the virtual environment. In this respect, in order to view a scene behind the user in the virtual environment, then the user is required to rotate their head or otherwise turn around. Similarly, a user is required to move around in a real world environment to similarly move around and navigate within the virtual environment. However, this is often not possible when the movement of the user in the real world is restricted, such as when located in a seated position in the real world. Also, since the user is only presented with a view of the virtual environment when moving around, then there is a risk that the user may trip or fall over obstacles in the real world environment.

In accordance with the present invention, there is provided a method of navigating viewable content within a virtual environment generated by a virtual reality system, the virtual reality system comprising:
a display for displaying the virtual environment comprising viewable content in a virtual reference frame to a user;
at least one head mountable sensor for sensing a tilt of the user's head in a real reference frame;

the method comprising the steps of moving the virtual reference frame relative to the real reference frame in response to the tilt of the user's head to present the viewable content to the viewer.

In an embodiment, the method comprises moving the virtual reference frame in a first direction relative to the real reference frame in response to a tilt of the user's head in a first direction and moving the virtual reference frame in a second direction relative to the real reference frame in response to a tilt of the user's head in a second direction.

In an embodiment, the method comprises sensing a tilt of the user's head relative to an axis which extends substantially horizontally in the real reference frame.

In an embodiment, the virtual reference frame is arranged to rotate within the real reference frame in response to the tilt of the user's head, such that viewable content disposed behind the user in the virtual reference frame is brought into view by the user. The rate of rotation of the virtual reference frame is dependent on the amount of tilt of the user's head sensed by the at least one sensor. Alternatively, or in addition thereto, the rate of rotation may vary, such as progressively increase, in accordance with the length of time the user's head remains in a tilted orientation.

In an embodiment, the method may further comprise selecting a navigation mode from a list comprising an input mode and a viewing mode. The input mode comprises viewable content, such as a list of selectable menu options, which may be selected to provide an input to the virtual reality system. The viewing mode comprises viewable content presented as a portion or scene within the virtual environment, such that a user can access a scene disposed behind the user in the virtual reference frame, without rotating their head or otherwise manoeuvring in the real reference frame.

Whilst the invention has been described above, it extends to any inventive combination of features set out above or in the following description. Although illustrative embodiments of the invention are described in detail herein with reference to the accompanying drawings, it is to be understood that the invention is not limited to these precise embodiments.

Furthermore, it is contemplated that a particular feature described either individually or as part of an embodiment can be combined with other individually described features, or parts of other embodiments, even if the other features and embodiments make no mention of the particular feature. Thus, the invention extends to such specific combinations not already described.

The invention may be performed in various ways, and, by way of example only, embodiments thereof will now be described, reference being made to the accompanying drawings in which:

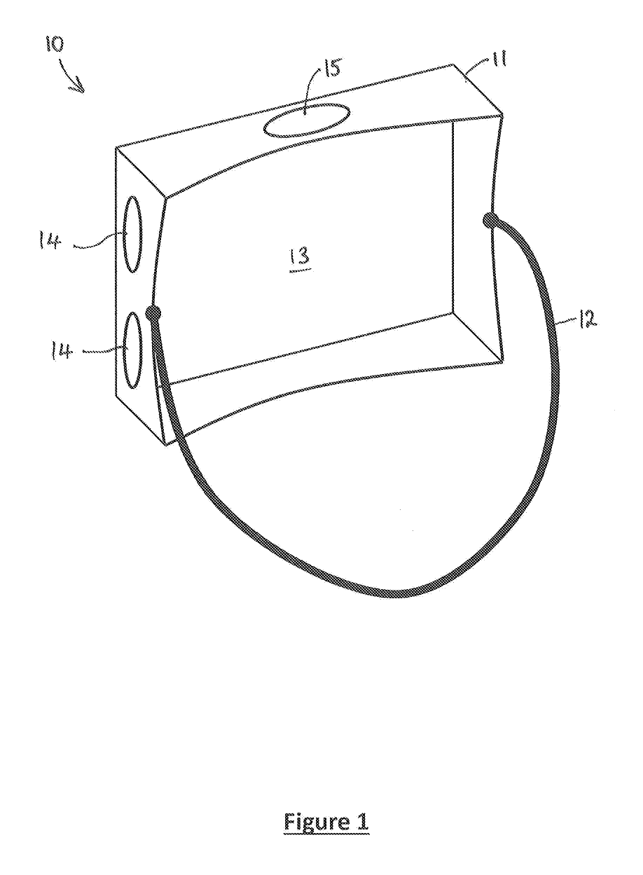

FIG. 1 is a perspective view of a virtual reality system; and,

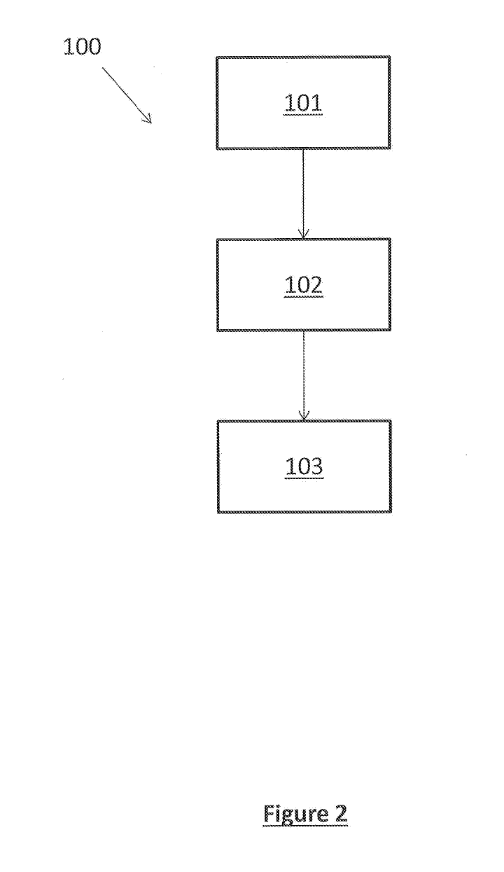

FIG. 2 is a schematic illustration of the steps associated with a method according to an embodiment of the present invention.

Referring to FIG. 1 of the drawings, there is illustrated a virtual reality system 10 for presenting a virtual environment to a user. The system 10 comprises a headset which is worn by the user (not shown) and comprises a housing which is arranged to extend around the eye region (not shown) of the user to block a view of the real world environment. The housing 11 may be secured to the user's head via one or more straps 12 for example. Alternatively, the housing may form part of a helmet (not shown) which is worn by the user.

The housing 11 comprises a display screen 13 for displaying a virtual environment to the user and at least one sensor 14 fixed relative to the housing 11 and arranged to move in correspondence with movements of the housing 11. In this respect, the at least one sensor 14 may be rigidly coupled with the housing 11, or detachably coupled therewith. The at least one sensor 14 may comprise an accelerometer or a gyroscope for sensing a tilt of the users head, as distinct from a rotation of the user's head, about a substantially horizontal axis within a real world reference frame. In an embodiment, the at least one sensor 14 comprises at least one gyroscope and at least one accelerometer and each of the at least one sensor is arranged to output a signal to a control module 15.

The control module 15 controls the viewable content of the virtual environment which is presented to the user in a virtual reference frame on the display screen 13. The viewable content presented is dependent upon the signal output from the at least one sensor 14. In this respect a sensed head tilt in a first or second direction for example, is arranged to cause a movement of the virtual reference frame relative to the real world reference frame, to present the viewable content to the user, without the need for the user to rotate their head within the virtual reference frame, for example.

The sensed head tilt is further arranged to control a rate of movement of the virtual reference frame relative to the real reference frame. For example, a large head tilt may cause a fast movement of the virtual reference frame and thus viewable content, relative to the real world reference frame, whereas a small head tilt may cause a slow movement of the virtual reference frame. Alternatively, or in addition thereto, the control module 15 may vary the rate of movement of the virtual reference frame in accordance with the length of time the user's head remains in a tilted orientation. For example, the rate of movement of the virtual reference frame may progressively increase as the time spent by a user adopting a particular head tilt increases.

The control module 15 is further arranged to control the type of interaction the user has with the virtual reality system 10. The control module 15 is arranged to permit the user to interact with the virtual reality system 10 by presenting two navigation modes to the user, namely an input mode and a viewing mode. The input mode comprises viewable content, such as a list of icons or selectable menu options, which may be selected by the user to provide an input command to the virtual reality system 10. The viewing mode comprises viewable content presented as a portion or scene within the virtual environment. However, in either mode a user is permitted to access or navigate viewable content in accordance with head gestures, namely head tilts.

Referring to FIG. 2 of the drawings, there is illustrated a method 100 of navigating viewable content within a virtual environment generated by a virtual reality system 10. The viewable content may comprise scenes within the environment, or a series of scrollable icons or menu options for example, which extend in a virtual reference frame. During use of the virtual reality system 10, the user first selects the navigation mode at step 101, such as viewing mode, and when a user wishes to navigate to a particular scene within the virtual environment, such as a view of the scene located behind the user in the virtual reference frame, the user tilts their head in a first or second direction, such as a head tilt to the left or right at step 101. The head tilt is sensed by the at least one sensor 14 which outputs a signal at step 102 to the control module 15. The control module 15 subsequently moves the virtual reference frame relative to a reference frame of the real world to cause the view of the scene to move in front of the user without the user having to rotate their head. Accordingly, viewable content is presentable to the user by moving the virtual reference frame relative to a real reference frame (namely a real world reference frame) in accordance with a tilt of the users head. In this respect, it is envisaged that a head tilt to the left or right may cause the virtual reference frame to rotate about a vertical axis relative to the real reference frame, to cause the viewable content to rotate around the user in a clockwise and anticlockwise direction, respectively. Similarly, a head tilt forward or backward may cause the virtual reference frame to rotate about a horizontal axis relative to the real world reference frame, to cause the viewable content to rotate in a forward or backward direction around the user, respectively. Moreover, a user may alter the rate at which the virtual reference frame is rotated at step 103 by increasing the amount of head tilt for example.

From the foregoing therefore, it is evident that the method allows the user to experience a 360° view of the virtual environment and menu options without discomfort or potential risk involved in rotating their head.

1. A method of navigating viewable content within a virtual environment generated by a virtual reality system, the virtual reality system comprising:
a display for displaying the virtual environment comprising viewable content in a virtual reference frame to a user;
at least one head mountable sensor for sensing a tilt of the user's head in a real reference frame;
the method comprising the steps of moving the virtual reference frame relative to the real reference frame in response to the tilt of the user's head to present the viewable content to the viewer, rotating the virtual reference frame within the real reference frame in response to the tilt of the user's head, wherein a rate of rotation of the virtual reference frame is dependent on the amount of tilt of the user's head sensed by the at least one sensor.

2. A method according to claim 1, further comprising moving the virtual reference frame in a first direction relative to the real reference frame in response to a tilt of the user's head in a first direction and moving the virtual reference frame in a second direction relative to the real reference frame in response to a tilt of the user's head in a second direction.

3. A method according to claim 1, further comprising sensing a tilt of the user's head relative to an axis which extends substantially horizontally in the real reference frame.

4. A method according to claim 1, wherein a rate of rotation varies in accordance with the length of time the user's head remains in a tilted orientation.

5. A method according to claim 1, further comprising selecting a navigation mode from a list comprising an input mode and a viewing mode.

6. A method according to claim 5, wherein the input mode comprises viewable content which may be selected to provide an input to the virtual reality system and the viewing mode comprises viewable content presented as a scene within the virtual environment.
